(19) United States
(12) Patent Application Publication
(10) Pub. No.: US 2020/0249325 A1
(43) Pub. Date: Aug. 6, 2020

(54) LIDAR LIGHT SOURCE

(71) Applicant: Shenzhen Genorivision Technology Co., Ltd., Shenzhen (CN)

(72) Inventors: Peiyan CAO, Shenzhen (CN); Yurun LIU, Shenzhen (CN)

(21) Appl. No.: 16/857,590

(22) Filed: Apr. 24, 2020

Related U.S. Application Data
(63) Continuation of application No. PCT/CN2017/107777, filed on Oct. 26, 2017.

(51) Int. Cl. G01S 7/481

(52) U.S. Cl. CPC G01S 7/4817; G01S 7/4814; G01S 7/4818

(57) ABSTRACT

Disclosed herein is an apparatus suitable for generating a scanning light beam. The apparatus may comprise a plurality of optical waveguides and an electronic control system. The plurality of optical waveguides each may comprise an input end, an optical core and an output end, the output ends arranged to line up in a first dimension. The electronic control system may be configured to adjust dimensions of the optical cores of the plurality of optical waveguides by regulating temperatures of the optical cores of the plurality of optical waveguides in order to control phases of output light waves from the plurality of optical waveguides for the output light waves to form a scanning light beam and control the scanning light beam to scan in the first dimension. The apparatus may further comprise an optical device configured to steer the scanning light beam in a second dimension.

### TECHNICAL FIELD

The disclosure herein relates to lidar light sources, particularly relates to a lidar light source with steering control.

### BACKGROUND

Lidar is a laser-based method of detection, range finding and mapping, which uses a technology similar to radar. There are several major components to a lidar system: laser, scanner and optics, photo detectors and receiver electronics. For example, controlled steering of scanning laser beams is carried out, and by processing the captured return signals reflected from distant objects, buildings and landscapes, distances and shapes of these objects, buildings and landscapes may be obtained.

Lidar is widely used. For example, autonomous vehicles (e.g., driverless cars) use lidar (also known as on-vehicle lidar) for obstacle detection and collision avoidance to navigate safely through environments. An on-vehicle lidar is mounted on the roof of a driverless car and it rotates constantly to monitor the current environment around the car. The lidar sensor provides the necessary data for software to determine where potential obstacles exist in the environment, help identify the spatial structure of the obstacle, distinguish objects based on size and estimate the impact of driving over it. One advantage of the lidar systems compared to radar systems is that the lidar systems can provide better range and a large field of view, which helps detecting obstacles on the curves. Despite tremendous progress has been made in lidar development in recent years, a lot of efforts are still being made these days to better design the lidar light sources to perform controlled scanning.

### SUMMARY

Disclosed herein is an apparatus, comprising: a plurality of optical waveguides each comprising an input end, an optical core and an output end, wherein the output ends of the plurality of optical waveguides are arranged to line up in a first dimension, wherein the input ends of the plurality of optical waveguides are configured to receive an input light beam; and an electronic control system configured to adjust dimensions of the optical cores of the plurality of optical waveguides by regulating temperatures of the optical cores of the plurality of optical waveguides, wherein by adjusting the dimensions of the optical cores of the plurality of optical waveguides the electronic control system is configured to control phases of output light waves from the plurality of optical waveguides for the output light waves to form a scanning light beam and control the scanning light beam to scan in the first dimension.

According to an embodiment, the plurality of optical waveguides is formed on a surface of a common substrate.

According to an embodiment, at least one optical waveguide is curved.

According to an embodiment, the apparatus further comprises an optical device configured to change a direction of the scanning light beam from the plurality of optical waveguides to scan in a second dimension perpendicular to the first dimension.

According to an embodiment, the optical device is a mirror comprising a plurality of faces, wherein the mirror is configured to let the scanning light beam reflect off from one of the plurality of faces while the mirror rotates.

According to an embodiment, the optical device is a lens configured to let the scanning light beam pass through while the lens moves back and forth in the second dimension.

According to an embodiment, the optical device is a mirror configured to let the scanning light beam reflect off while the mirror rotates, or moves back and forth in the second dimension or a third dimension perpendicular to the first and second dimensions.

According to an embodiment, light waves of the input light beam to the plurality of optical waveguides are coherent.

According to an embodiment, the apparatus further comprises a beam expander configured to expand the input light beam before the input light beam enters the plurality of optical waveguides.

According to an embodiment, the apparatus further comprises a one-dimensional diffraction grating configured to couple the light waves of the input light beam into the plurality of optical waveguides.

According to an embodiment, the one-dimensional diffraction grating is a cylindrical microlens array.

According to an embodiment, the scanning light beam is a laser beam.

According to an embodiment, at least one optical core comprises an optical medium that is conductive and transparent.

According to an embodiment, the at least one optical core is electronically connected to the electronic control system, wherein the electronic control system is configured to control the temperature of at least one optical core by applying an electric current flowing through the at least one optical core.

According to an embodiment, at least one of the plurality of optical waveguides further comprises a conductive cladding around sidewalls of a respective optical core.

According to an embodiment, the conductive cladding is electronically connected to the electronic control system, wherein the electronic control system is configured to control the temperature of the respective optical core by applying an electric current flowing through the conductive cladding.

According to an embodiment, the apparatus further comprises a temperature modulation element electrically connected to the electronic control system, where in the electronic control system is configured to control the temperature of at least one optical core by adjusting the temperature of the temperature modulation element.

According to an embodiment, the temperature modulation element and the plurality of optical waveguides are formed on a common substrate.

According to an embodiment, the apparatus further comprises a diffraction grating configured to modulate the scanning light beam.

According to an embodiment, the diffraction grating is a cylindrical microlens array.

According to an embodiment, the diffraction grating is a one-dimensional Fresnel lens array.

According to an embodiment, at least one of the plurality of optical waveguides is on one substrate and at least another of the plurality of optical waveguides is on a separated substrate.

Disclosed herein is a system suitable for laser scanning, the system comprising: the apparatus of any one of the apparatuses above, a laser source, wherein the apparatus is configured to receive an input laser beam from the laser source and generate a scanning laser beam.

According to an embodiment, the system further comprises a detector configured to collect return laser signals after the scanning laser beam bounces off of an object.

According to an embodiment, the system further comprises a signal processing system configured to process and analyze the return laser signals detected by the detector.

### BRIEF DESCRIPTION OF FIGURES

FIG. 1 schematically shows a perspective view of an apparatus suitable for generating a scanning light beam, according to an embodiment.

FIG. 2 schematically shows a cross-sectional view of an apparatus, according to an embodiment.

FIG. 3A schematically shows an apparatus comprising an optical device, according to one embodiment.

FIG. 3B schematically shows an apparatus comprising an optical device, according to another embodiment.

FIG. 3C schematically shows an apparatus comprising an optical device, according to another embodiment.

FIG. 4A schematically shows a cross-sectional view of an apparatus, according to one embodiment.

FIG. 4B schematically shows a cross-sectional view of an apparatus, according to another embodiment.

FIG. 4C schematically shows a cross-sectional view of an apparatus, according to an embodiment.

FIG. 5 schematically shows a system suitable for laser scanning, according to an embodiment.

### DETAILED DESCRIPTION

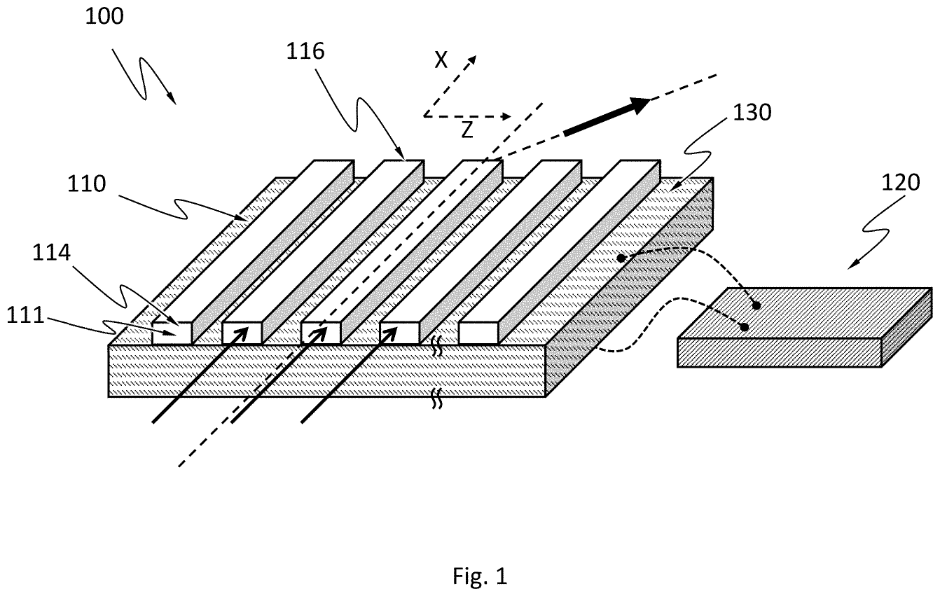

FIG. 1 schematically shows a perspective view of an apparatus 100 suitable for generating a scanning light beam, according to an embodiment. The apparatus 100 may comprise a plurality of optical waveguides 110 and an electronic control system 120. The plurality of optical waveguides 110 may be controlled by the electronic control system 120. Each of the optical waveguides 110 may comprise an input end 114, an optical core 111 and an output end 116.

Each optical core 111 may comprise an optical medium. In one embodiment, the optical medium may be transparent. Dimensions of each of the optical cores 111 may be individually adjusted by the electronic control system 120 to control phases of output light waves from respective optical cores 111. The electronic control system 120 may be configured to individually adjust the dimensions of each of the optical cores 111 by regulating the temperature of each of the optical cores 111 respectively.

The input ends 114 of the optical waveguides 110 may receive input light waves of an input light beam and the received light waves may pass through the optical cores 111 and exit as output light waves from the output ends 116 of the optical waveguides 110. Diffraction may let the output light waves from each of the optical cores 111 spread over a wide angle so that when the input light waves are coherent (e.g., from a coherent light source such as a laser), the output light waves from the plurality of optical waveguides 110 may interfere with each other and exhibit an interference pattern. In one embodiment, the output ends 116 of the plurality of optical waveguides 110 may be arranged to line up in a first dimension. For example, as shown in FIG. 1, the output ends 116 of the plurality of optical waveguides 110 may be lined up in the Z dimension. This way, the output interface of each waveguides 110 may face the X direction. The electronic control system 120 may be configured to control phases of the output light waves from the plurality of optical waveguides 110 for the interference pattern to generate a scanning light beam and steer the scanning light beam in the first dimension.

In one embodiment, the light waves of the input light beam to the plurality of optical waveguides 110 may be at a same phase. The interference pattern of the output light waves from the plurality of optical waveguides 110 may comprise one or more propagating bright spots where output light waves constructively interfere (e.g., re-enforce) and one or more propagating weak spots where output light waves destructively interfere (e.g., cancel out each other). In one embodiment, the one or more propagating bright spots may form one or more scanning light beams generated by the apparatus 100. If the phases of the output light waves of the optical cores 111 shift and the phase differences between the output light waves change, the constructive interferences may happen at different directions so that the interference pattern of the output light waves (e.g., the directions of the one or more generated scanning light beams) may also change. In other words, light beam steering in the first dimension may be realized by adjusting the phases of the output light beams from the plurality of optical waveguides 110.

One way of adjusting the phases of the output light waves is changing the effective optical paths of the light waves propagated through the optical cores 111. An effective optical path of a light wave propagated through an optical medium may depend on the physical distance the light travels in the optical medium (e.g., depending on incident angle of the light wave, dimensions of the optical medium). As a result, the electronic control system 120 may adjust the dimensions of the optical cores 111 to change the effective optical paths of incident light beam propagates through the optical cores 111 so that the phases of the output light waves may shift under the control of the electronic control system 120. For example, the length of each of the optical cores 111 may change because at least a part of the respective optical cores 111 has a temperature change. Moreover, the diameter of at least a section of an optical core 111 may change if at least part of the section of the optical core 111 has a temperature change. Therefore, in one embodiment, regulating the temperature of each of the optical cores 111 may be used to control the dimensions of the optical cores 111 due to the thermal expansion or contractions of the optical cores 111.

It should be noted that although FIG. 1 shows the plurality of optical waveguides 110 are arranged in parallel, this is not required in all embodiments. In some embodiments, the output ends 116 may be lined up in a dimension but the plurality of optical waveguides 110 need not be straight or be arranged in parallel. For example, in one embodiment, at least one of the optical waveguide 110 may be curved (e.g., “U” shaped, “S” shaped, etc.). The cross-sectional shape of the optical waveguides 110 may be a rectangle, circle, or any other suitable shape. In one embodiment, the plurality of optical waveguides 110 may lie on a surface of a substrate 130. In example of FIG. 1, the plurality of optical waveguides 110 forms a one-dimensional array placed on a surface of the substrate 130. The optical waveguides 110 need not to be evenly distributed in the one-dimensional array. The substrate 130 may include conductive, non-conductive or semiconductor materials. In an embodiment, the substrate 130 may include a material such as silicon dioxide. The electronic control system 120 may be embedded in the substrate 130 but also may be placed outside of the substrate 130. In other embodiments, the plurality of optical waveguides 110 needs not to be on one substrate. For example, some optical waveguides 110 may be on one substrate, some other optical waveguides 110 may be on a separate substrate.

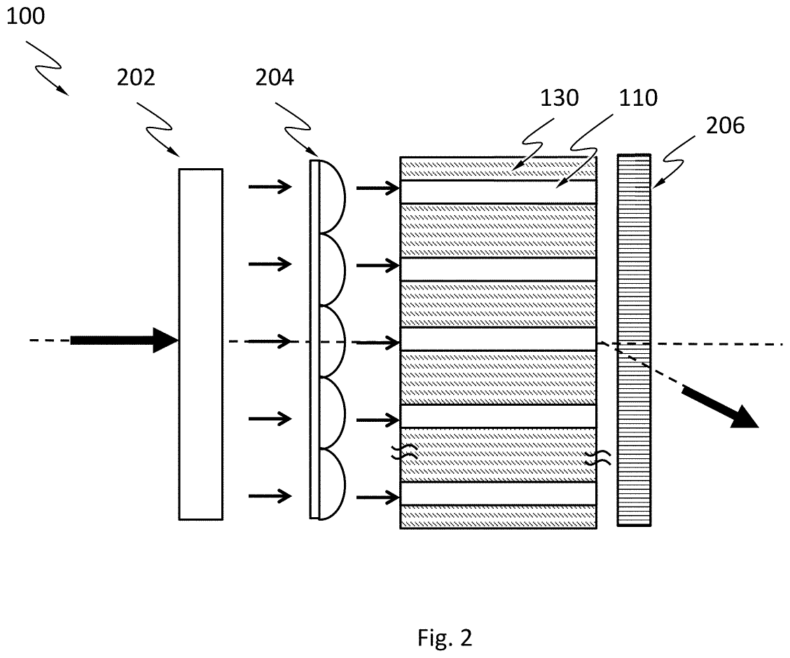

FIG. 2 schematically shows a cross-sectional view of the apparatus 100, according to an embodiment. The apparatus 100 may further comprise a beam expander 202 (e.g., a group of lenses). The beam expander 202 may expand the input light beam before the input light beam enters the plurality of optical waveguides 110. The expanded input light beam may be collimated. In an embodiment, the beam expander 202 may expand the input light beam in the first dimension. In an embodiment, the apparatus 100 may further comprise a one-dimensional diffraction grating (e.g., a cylindrical microlens array 204) configured to converge and couple the light waves of the input light beam into the plurality of optical waveguides 110. The apparatus 100 may further comprise one or more diffraction gratings 206 (such as cylindrical microlens array or one-dimensional Fresnel lens array) configured to modulate the output light waves from the plurality of optical waveguides 110.

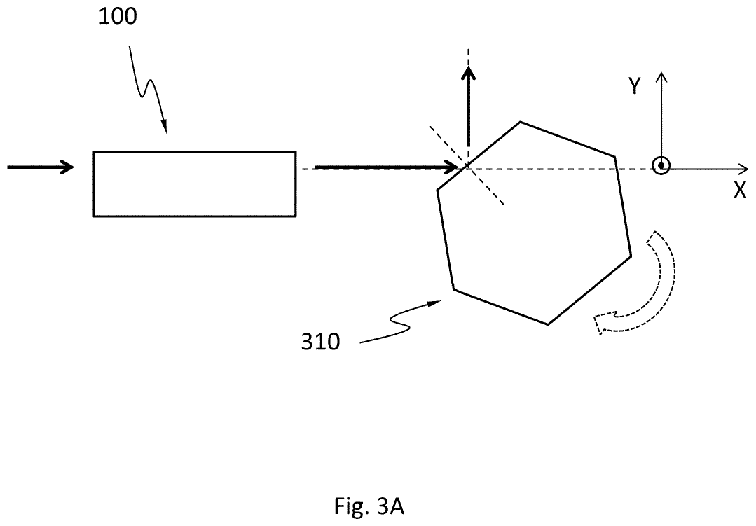

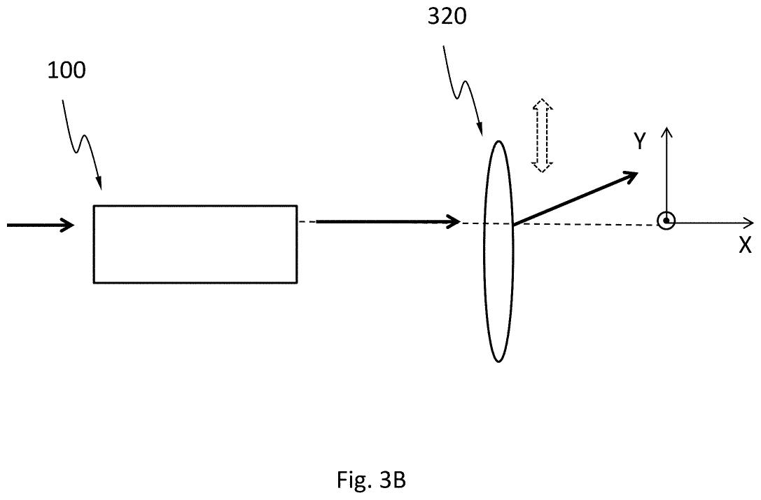

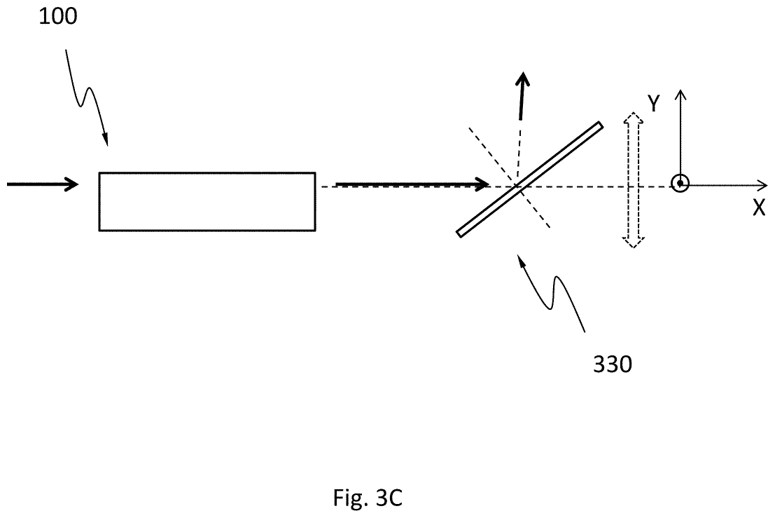

FIG. 3A schematically shows the apparatus 100 comprising an optical device configured to change the direction of the scanning light beam from the plurality of optical waveguides 110 to scan in a second dimension, according to an embodiment. The optical device may be a mirror 310 comprising a plurality of faces (e.g., a hexagonal mirror). The mirror 310 may be driven by an electrical or mechanical drive unit to rotate. The scanning light beam from the plurality of optical waveguides 110 hits on one of the plurality of faces and reflects off from the face incident thereon. The angle of incidence between the incident scanning light beam and the normal of the face incident thereon changes while the mirror 310 rotates so that the angle of reflection changes accordingly and the reflected scanning light beam scans in the second dimension. In example of FIG. 3A, the scanning light beam from plurality of optical waveguides 110 may be configured to scan in the Z dimension (Z direction is pointing out of the page) by regulating temperatures of the optical waveguides 110, and rotating the mirror 310 further allows the scanning light beam scan in the X dimension. In other words, the apparatus 100 in example of FIG. 3A is configured to perform a two-dimensional scan in the X-Z plane. In one embodiment, the electrical or mechanical drive unit may be electronically connected to and be controlled by the electronic control system 120 so that the rotational speed of the mirror 310 can be adjusted to control the scanning speed of the scanning light beam in the second dimension.

FIG. 3B schematically shows another embodiment in which the optical device may be a lens 320 configured to change the direction of the scanning light beam from the plurality of optical waveguides 110 to scan in a second dimension. The lens 320 may be controlled by an electrical or mechanical drive unit and able to move back and forth in the second dimension (e.g., up and down in Y dimension). The scanning light beam from the plurality of optical waveguides 110 passes through the lens 320 and gets refracted. The direction of the scanning light beam after passing through the lens 320 changes while the lens moves back and forth in the second dimension. As a result, the scanning light beam after passing through the lens 320 scans in the second dimension. In example of FIG. 3B, the scanning light beam from plurality of optical waveguides 110 may be controlled by the electronic control system 120 to scan in the Z dimension (Z direction is pointing out of the page), and moving the lens 320 up and down along the Y dimension allows the scanning light beam scan in the Y dimension. In other words, the apparatus 100 in example of FIG. 3B is configured to perform a two-dimensional scan in the Y-Z plane. In one embodiment, the electrical or mechanical drive unit may be electronically connected to and controlled by the electronic control system 120 so that the moving speed of the lens 320 can be adjusted to control the scanning speed of the scanning light beam in the second dimension.

FIG. 3C schematically shows another embodiment in which the optical device may be a mirror 330 configured to change the direction of the scanning light beam from the plurality of optical waveguides 110 to scan in a second dimension. The mirror 330 may be a plane mirror or a curved mirror. The mirror 330 may be controlled by an electrical or mechanical drive unit and able to move back and forth in one dimension (e.g., in Y or X dimension) or rotate. The scanning light beam from the plurality of optical waveguides 110 may hit on and reflect off from the mirror 330. If the mirror 330 rotates, the angle of incidence between the incident scanning light beam and the normal of the mirror 330 incident thereon changes while the mirror 330 rotates so that the angle of reflection changes accordingly and the reflected scanning light beam scans in the second dimension (e.g., in X dimension). If the mirror 330 move back and forth in Y or X dimension, the point of incidence for the scanning light beam changes back and forth in X dimension so that the reflected scanning light beam scans in X dimension. In example of FIG. 3C, the scanning light beam from plurality of optical waveguides 110 may be controlled by the electronic control system 120 to scan in the Z dimension (Z direction is pointing out of the page), and moving the mirror 330 back and forth in the Y dimension further allows the scanning light beam scan in the X dimension. In other words, the apparatus 100 in example of FIG. 3C is configured to perform a two-dimensional scan in the X-Z plane. In one embodiment, the electrical or mechanical drive unit may be electronically connected to and be controlled by the electronic control system 120 so that the rotational or moving speed of the mirror 330 can be adjusted to control the scanning speed of the scanning light beam in the second dimension.

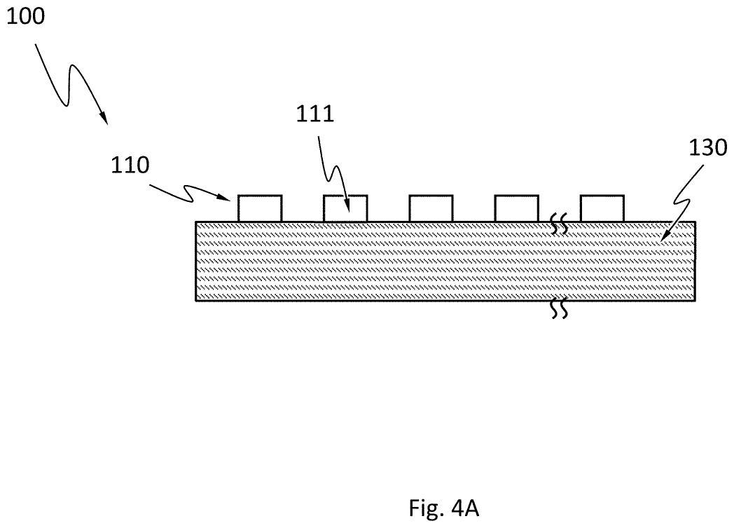

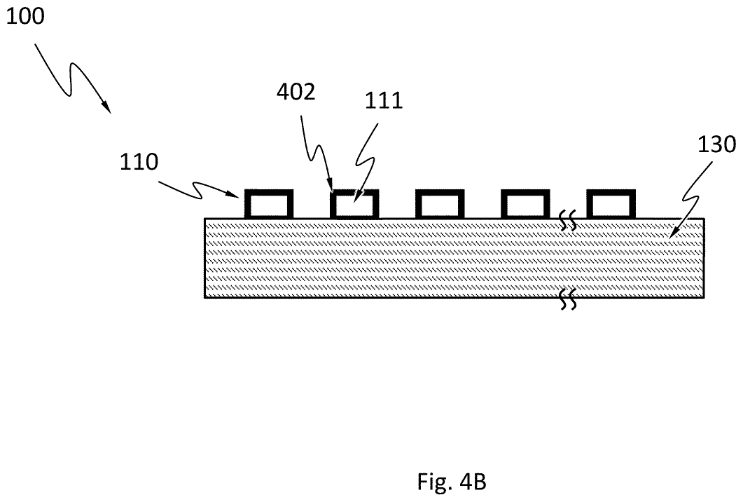

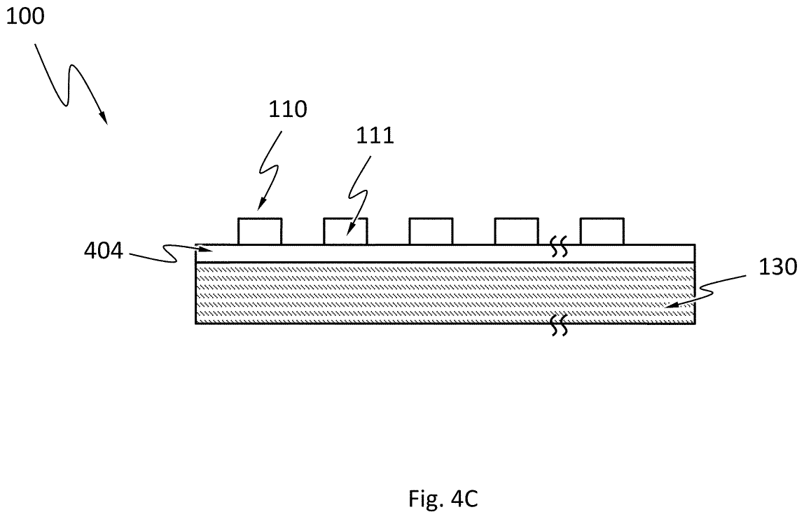

FIG. 4A schematically shows a cross-sectional view of the apparatus 100, according to one embodiment. Each of the optical cores 111 may comprise an optical medium that is conductive and transparent. The optical cores 111 may be electrically connected to the electronic control system 120. In an embodiment, the electronic control system 120 may be configured to individually adjust the dimensions of each of the optical cores 111 by individually regulating the temperature of each of the optical cores 111. The electronic control system 120 may apply an electric current to each of the optical cores 111 respectively. The temperature of each of the optical cores 111 may be individually regulated by controlling the magnitude of the electric current flowing through each of the optical cores 111.

FIG. 4B schematically shows a cross-sectional view of the apparatus 100, according to another embodiment. Each of the optical waveguides 110 may comprise a conductive cladding 402 around sidewalls of a respective optical core 111. In an embodiment, each of the conductive claddings 402 may be electronically connected to the electronic control system 120. The electronic control system 120 may be configured to individually adjust the dimensions of each of the optical cores 111 by regulating the temperature of each of the optical cores 111. The electronic control system 120 may apply an electric current to each of the conductive cladding 402. The temperature of each of the optical cores 111 may be regulated individually by controlling the magnitude of each of the electric current flowing through each of the respective conductive cladding 402 due to heat transfer between the optical core 111 and the respective conductive cladding 402.

FIG. 4C schematically shows a cross-sectional view of the apparatus 100, according to an embodiment. The apparatus 100 may comprise one or more temperature modulation elements. A temperature modulation element may convert voltage or current input into a temperature difference that may be used for either heating or cooling. For example, a temperature modulation element may be a Peltier device. The one or more temperature modulation elements may be able to transfer heat to or from the plurality of optical waveguides 110. In an embodiment, the one or more temperature modulation elements may be in contact with the plurality of optical waveguides 110. In an embodiment, the one or more temperature modulation elements are electronically connected to the electronic control system 120. The electronic control system 120 may be configured to control the temperature of at least one optical core 111 by adjusting the temperature of the one or more temperature modulation elements due to heat transfer between the plurality of optical waveguides 110 and the one or more temperature modulation elements. In one embodiment, the one or more temperature modulation elements may share a common substrate with the plurality of optical waveguides 110. In example of FIG. 4C, the apparatus 100 comprises a layer 404, which may comprise the one or more temperature modulation elements on a surface of the substrate 130, and may be in contact with the plurality of optical waveguides 110.

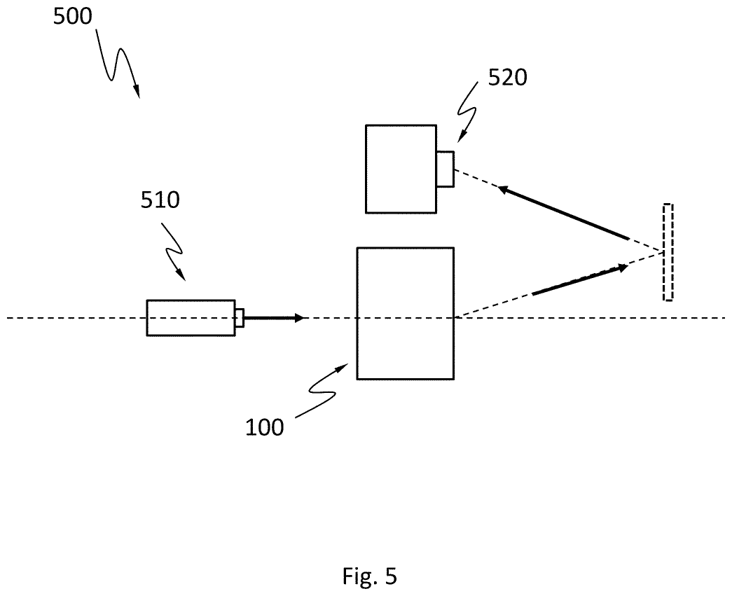

FIG. 5 schematically shows a system 500 suitable for laser scanning, according to an embodiment. The system 500 comprises a laser source 510 and an embodiment of an apparatus 100 described herein. The apparatus 100 is configured to receive an input laser beam from the laser source 510 and may generate a scanning laser beam due to light diffraction and interference. In one embodiment, the system 500 may perform one-dimensional laser scanning without moving part. In another embodiment, the system 500 may perform two-dimensional laser scanning. The system 500 may be used together with a detector 520 and a signal processing system in a Lidar system (e.g., an on-vehicle Lidar). The detector is configured to collect return laser signals after the scanning laser beam bounces off of an object, building or landscape. The signal processing system is configured to process and analyze the return laser signals detected by the detector. In one embodiment, the distance and shape of the object, building or landscape may be obtained.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An apparatus, comprising:
a plurality of optical waveguides each comprising an input end, an optical core and an output end, wherein the output ends of the plurality of optical waveguides are arranged to line up in a first dimension, wherein the input ends of the plurality of optical waveguides are configured to receive an input light beam; and
an electronic control system configured to adjust dimensions of the optical cores of the plurality of optical waveguides by regulating temperatures of the optical cores of the plurality of optical waveguides,
wherein by adjusting the dimensions of the optical cores of the plurality of optical waveguides the electronic control system is configured to control phases of output light waves from the plurality of optical waveguides for the output light waves to form a scanning light beam and control the scanning light beam to scan in the first dimension.

2. The apparatus of claim 1, wherein the plurality of optical waveguides is formed on a surface of a common substrate.

3. The apparatus of claim 1, wherein at least one of the plurality of optical waveguides is curved.

4. The apparatus of claim 1, further comprising an optical device configured to change a direction of the scanning light beam to scan in a second dimension perpendicular to the first dimension.

5. The apparatus of claim 4, wherein the optical device is a mirror comprising a plurality of faces, wherein the mirror is configured to let the scanning light beam reflect off from one of the plurality of faces while the mirror rotates.

6. The apparatus of claim 4, wherein the optical device is a lens configured to let the scanning light beam pass through while the lens moves back and forth in the second dimension.

7. The apparatus of claim 4, wherein the optical device is a mirror configured to let the scanning light beam reflect off while the mirror rotates, or moves back and forth in the second dimension or a third dimension perpendicular to the first and second dimensions.

8. The apparatus of claim 1, wherein light waves of the input light beam to the plurality of optical waveguides are coherent.

9. The apparatus of claim 1, further comprising a beam expander configured to expand the input light beam before the input light beam enters the plurality of optical waveguides.

10. The apparatus of claim 1, further comprising a one-dimensional diffraction grating configured to couple the light waves of the input light beam into the plurality of optical waveguides.

11. The apparatus of claim 10, wherein the one-dimensional diffraction grating is a cylindrical microlens array.

12. The apparatus of claim 1, wherein the scanning light beam is a laser beam.

13. The apparatus of claim 1, wherein at least one optical core comprises an optical medium that is conductive and transparent.

14. The apparatus of claim 13, wherein the at least one optical core is electronically connected to the electronic control system, wherein the electronic control system is configured to control the temperature of at least one optical core by applying an electric current flowing through the at least one optical core.

15. The apparatus of claim 1, wherein at least one of the plurality of optical waveguides further comprises a conductive cladding around sidewalls of a respective optical core.

16. The apparatus of claim 15, wherein the conductive cladding is electronically connected to the electronic control system, wherein the electronic control system is configured to control the temperature of the respective optical core by applying an electric current flowing through the conductive cladding.

17. The apparatus of claim 1, further comprising a temperature modulation element electrically connected to the electronic control system, where in the electronic control system is configured to control the temperature of at least one optical core by adjusting the temperature of the temperature modulation element.

18. The apparatus of claim 17, wherein the temperature modulation element and the plurality of optical waveguides are formed on a common substrate.

19. The apparatus of claim 1, further comprising a diffraction grating configured to modulate the scanning light beam.

20. The apparatus of claim 19, wherein the diffraction grating is a cylindrical microlens array.

21. The apparatus of claim 19, wherein the diffraction grating is a one-dimensional Fresnel lens array.

22. The apparatus of claim 1, wherein at least one of the plurality of optical waveguides is on one substrate and at least another of the plurality of optical waveguides is on a separate substrate.

23. A system suitable for laser scanning, the system comprising:
the apparatus of claim 1,
a laser source,
wherein the apparatus is configured to receive an input laser beam from the laser source and generate a scanning laser beam.

24. The system of claim 23, further comprising a detector configured to collect return laser signals after the scanning laser beam bounces off of an object.

25. The system of claim 24, further comprising a signal processing system configured to process and analyze the return laser signals detected by the detector.
